(19) United States
(12) Patent Application Publication
(10) Pub. No.: US 2018/0137490 A1
(43) Pub. Date: May 17, 2018

(54) CASH DISPENSER APPARATUS, CHECKOUT SYSTEM, AND CASH DISPENSING METHOD

(71) Applicant: TOSHIBA TEC KABUSHIKI KAISHA, Tokyo (JP)

(72) Inventor: Yuji YASUI, Izunokuni Shizuoka (JP)

(21) Appl. No.: 15/804,538

(22) Filed: Nov. 6, 2017

(30) Foreign Application Priority Data
Nov. 11, 2016 (JP) 2016-220704

(51) Int. Cl. G06Q 20/18; G07D 1/06; G07D 1/02

(52) U.S. Cl. CPC G06Q 20/18; G07D 1/02; G07D 1/06

(57) ABSTRACT

According to an embodiment, a cash dispenser apparatus includes a cash-to-be-dispensed conveyer device, an informing device, and a controller. The cash-to-be-dispensed conveyer device dispenses cash from the storage device to the outside of the apparatus. The informing device informs that cash is being dispensed. The controller causes the cash-to-be-dispensed conveyer device to start a cash-dispensing operation, the cash-dispensing operation including dispensing cash from the storage device, an amount of the cash corresponding to a change amount based on the change information input by using the input device, and causes the informing device to execute the informing operation on condition that the cash-dispensing operation is uncompleted.

### CROSS-REFERENCE TO RELATED APPLICATIONS

This application is based upon and claims the benefit of priority from the prior Japanese Patent Application No. 2016-220704, filed on Nov. 11, 2016, the entire contents of which are incorporated herein by reference.

### FIELD

An embodiment to be described here generally relates to a cash dispenser apparatus, a checkout system including the cash dispenser apparatus, and a cash dispensing method.

### BACKGROUND

In recent years, apparatuses such as self checkout apparatuses, are installed in distribution and retail stores such as supermarkets, convenience stores, department stores, and restaurants. Customers input payment operations in such apparatuses. Such an apparatus includes a cash dispenser apparatus that dispenses change to a customer. The kinds of such cash dispenser apparatuses include a change dispenser machine for bills that dispenses stored bills, a change dispenser machine for coins that dispenses stored coins, and the like. Such cash dispenser apparatuses dispense bills and/or coins (hereinafter, collectively referred to as “cash”) as change, an amount of the change corresponding to information input from a POS (Point of Sales) terminal, for example.

By the way, in some cases, cash being dispensed may jam or overlap one another. Then a cash dispenser apparatus may not dispense cash as change in a predetermined time period.

In this case, a customer may misunderstand that all the change is dispensed when only part of the change is dispensed from the cash dispenser apparatus, and may leave from the cash dispenser apparatus with the part of the change.

In view of the above-mentioned circumstances, there is known an apparatus that temporarily stocks cash as change to be dispensed inside, and then dispenses all the stocked cash to a cash dispenser tray in a batch.

However, such an apparatus has a complicated structure, and the cost of the cash dispenser apparatus is thus increased.

### BRIEF DESCRIPTION OF THE DRAWINGS

FIG. 1 is a front view showing an outer appearance of a self checkout apparatus of an embodiment.

FIG. 2 is a perspective view showing an outer appearance of a part of the self checkout apparatus 100 seen from the above.

FIG. 3 is a plan view schematically showing an inner structure of a change dispenser machine for coins of this embodiment.

FIG. 4 is a block diagram showing a hardware configuration of the change dispenser machine for coins of this embodiment.

FIG. 5 is a functional block diagram showing a functional configuration of the change dispenser machine for coins of this embodiment.

FIG. 6 is a flowchart showing a control processing of controlling the change dispenser machine for coins of this embodiment.

### DETAILED DESCRIPTION

According to an embodiment, a cash dispenser apparatus includes a storage device, an input device, a cash-to-be-dispensed conveyer device, an informing device, and a controller. The storage device stores cash. The input device inputs change information. The cash-to-be-dispensed conveyer device dispenses cash from the storage device. The informing device informs that cash is being dispensed. The controller causes the cash-to-be-dispensed conveyer device to start a cash-dispensing operation, the cash-dispensing operation including dispensing cash from the storage device, an amount of the cash corresponding to a change amount based on the change information input by using the input device. The controller further causes the informing device to execute the informing operation on condition that the cash-dispensing operation is uncompleted.

Hereinafter, with reference to the drawings, a cash dispenser apparatus, a checkout system, and a cash dispensing method of an embodiment will be described in detail. In the drawings, the same reference symbols indicate the same or similar units. In this embodiment, a change dispenser machine for coins that accepts/dispenses coins will be described as an example of a cash dispenser apparatus. Further, coins will be described as an example of cash. Further, in this embodiment, a self checkout apparatus will be described as an example of a checkout system. A customer operates the self checkout apparatus by himself for a sales register operation for products and a payment operation. Note that the cash dispenser apparatus, the checkout system, and the cash dispensing method are not limited to those of the following embodiment.

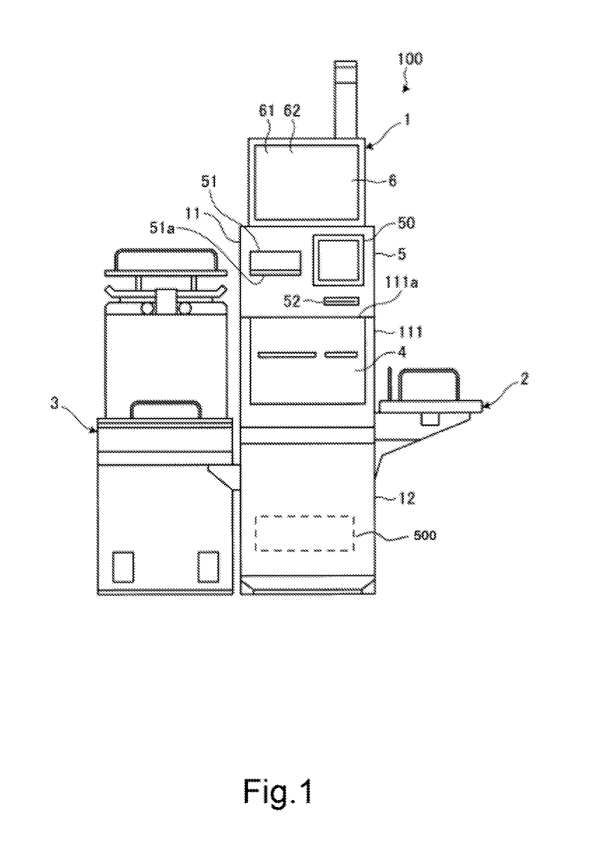

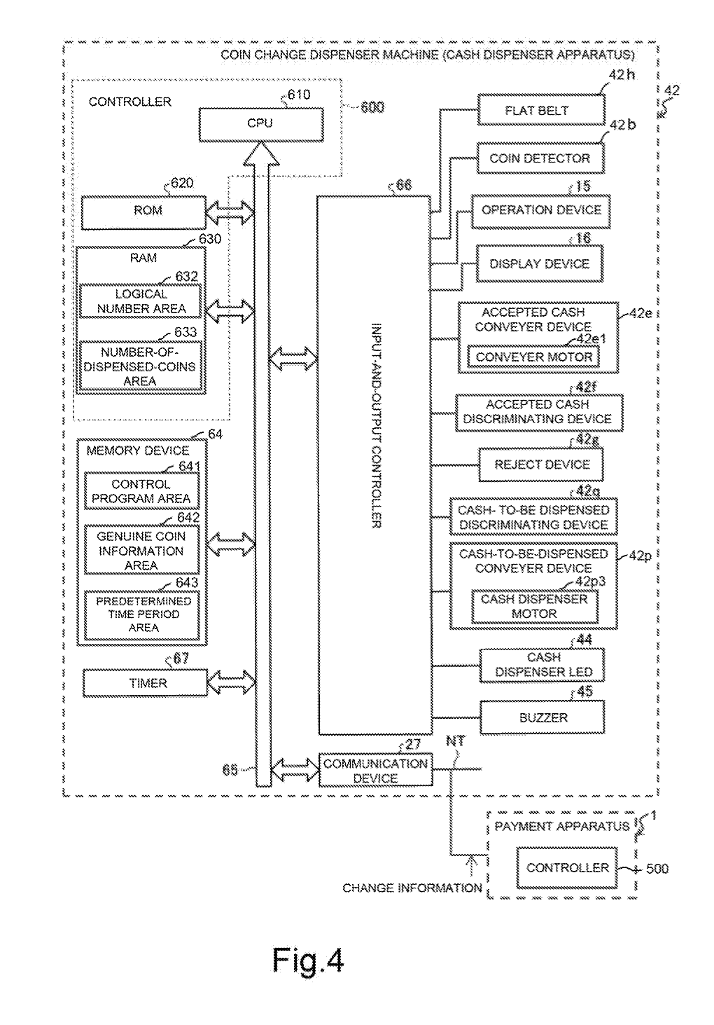

FIG. 1 is a front view showing an outer appearance of the self checkout apparatus 100 of this embodiment. As shown in FIG. 1, the self checkout apparatus 100 includes the payment apparatus 1, the basket table 2, the packing table 3, and the cash-acceptor-and-dispenser apparatus 4. The payment apparatus 1 includes the reader device 5, the operation panel 6, and the controller 500 that controls the respective units (see FIG. 4). Further, the payment apparatus 1 is connected to the cash-acceptor-and-dispenser apparatus 4.

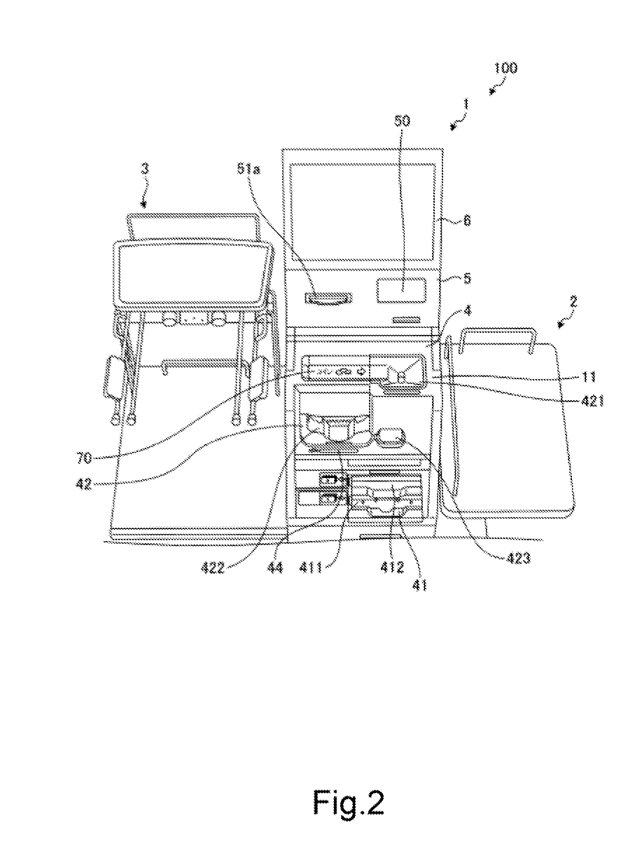

The payment apparatus 1 includes the first housing 11 and the second housing 12. The first housing 11 includes the openable and closable flap 111. The flap 111 rotates in the upper and lower directions at the front side, the hinge unit 111a being the center. The first housing 11 houses the cash-acceptor-and-dispenser apparatus 4 inside. The cash-acceptor-and-dispenser apparatus 4 includes the change dispenser machine for bills 41 and the change dispenser machine for coins 42 (both are shown in FIG. 2). The second housing 12 houses a power source, the controller 500, and the like inside.

The reader device 5 includes the scanner 50 that optically reads a code symbol (barcode, etc.) on a product in order to identify the product held by a customer over the scanner 50. Further, the reader device 5 includes the printer 51 that prints a receipt for the payment processing executed by the controller 500. The printer 51 includes the receipt outlet plate 51a that supports a discharged receipt. The receipt outlet plate 51a is a plate protruding from the first housing 11. Further, the reader device 5 includes the card reader 52 that reads a credit card or the like for the payment processing executed by the controller 500.

The operation panel 6 includes the monitor 61 and the touch panel 62. Controlled by the controller 500, the monitor 61 displays images. The touch panel 62 is provided on the front surface of the monitor 61, and outputs information based on a location touched by a customer to the controller 500.

A customer puts a basket on the basket table 2, i.e., a stillage, puts out products from the basket, and holds the products over the scanner 50 of the reader device 5. The basket table 2 is provided at one side (upstream side in flow direction of products) of the payment apparatus 1.

The customer packs the products, which have been held over the scanner 50, in a bag on the packing table 3. The packing table 3 is provided at the opposite side of the payment apparatus 1 (opposite side of the basket table 2).

Controlled by the controller 500, the payment apparatus 1 executes sales register processing and payment processing for products to be purchased by a customer. The sales register processing includes obtaining a product code on the basis of a code symbol such as a barcode read from a product to be purchased by a customer. The above-mentioned scanner 50 reads a code symbol such as a barcode. Further, the sales register processing includes displaying product information on the product, which is read from a product master (not shown) on the basis of the obtained product code, on the monitor 61. The product information is information of a product based on the obtained product code, and includes a product name, a price, and the like. Further, the sales register processing includes storing the product information in a RAM or the like. The payment processing includes displaying the total price of the transaction on the monitor 61 on the basis of the product information stored in the RAM or the like in the sales register processing. Further, the payment processing includes calculating change on the basis of cash received from a customer, and displaying the amount of the change on the monitor 61. Further, the payment processing includes instructing the change dispenser machine for bills 41 and the change dispenser machine for coins 42 to dispense change (dispense cash). Further, the payment processing includes issuing a receipt on which product information and payment information (total price, amount of received cash, and change amount, etc.) are printed, and other processing. The payment information includes a total price, an amount of received cash, a change amount, and the like.

The flap 111 is opened when it is rotated in the upper direction. When the flap 111 is open, the change dispenser machine for bills 41 and the change dispenser machine for coins 42 housed in the first housing 11 of the payment apparatus 1 are exposed (see FIG. 2). The first housing 11 houses the change dispenser machine for bills 41 and the change dispenser machine for coins 42 in tiers. The change dispenser machine for bills 41 is below the change dispenser machine for coins 42.

The change dispenser machine for bills 41 takes bills payed by a customer inside. Further, the change dispenser machine for bills 41 determines whether taken bills are genuine or counterfeit, and stores genuine bills. Further, the change dispenser machine for bills 41 dispenses stored bills as change. The change dispenser machine for coins 42 takes coins payed by a customer inside. Further, the change dispenser machine for coins 42 determines whether taken coins are genuine or counterfeit, and stores genuine coins. Further, the change dispenser machine for coins 42 dispenses stored coins as change. The change dispenser machine for bills 41 outputs information on an amount of stored bills to the controller 500 of the payment apparatus 1. The change dispenser machine for coins 42 outputs information on an amount of stored coins to the controller 500 of the payment apparatus 1. Further, the controller 500 of the payment apparatus 1 inputs change information indicating a change amount in the change dispenser machine for bills 41 and the change dispenser machine for coins 42. The change dispenser machine for bills 41 dispenses bills for change out of the change amount based on the change information. The change dispenser machine for coins 42 dispenses coins for change out of the change amount based on the change information.

The controller 500 integrally controls the respective units of the payment apparatus 1. Specifically, the controller 500 obtains information on a product code on the basis of the code symbol read by the reader device 5. Further, the controller 500 outputs information to be displayed on the monitor 61 of the operation panel 6. Further, the controller 500 obtains information on an operation input in the touch panel 62 of the operation panel 6 by a customer. Further, the controller 500 recognizes that the cash-acceptor-and-dispenser apparatus 4 accepts cash, and instructs the cash-acceptor-and-dispenser apparatus 4 to dispense cash.

Here, FIG. 2 is a perspective view showing an outer appearance of the self checkout apparatus 100 seen from the above. As shown in FIG. 2, the first housing 11 includes the cash tray 70. A customer temporarily puts coins, which the customer pays as payment for products, on the cash tray 70. The cash tray 70 is a concave portion. Further, the first housing 11 includes the coin insertion slot 421. The coin insertion slot 421 receives coins inserted for payment by a customer, and takes the coins in the change dispenser machine for coins 42. A customer slides necessary coins (for payment) out of the coins on the cash tray 70 toward the coin insertion slot 421, and inserts the coins in the coin insertion slot 421. The coin insertion slot 421 includes funnel-form sloping surfaces downward from the four sides of a rectangular shape, and an opening at the lowermost portion of the sloping surfaces.

Further, the first housing 11 includes the coin dispenser tray 422 of the change dispenser machine for coins 42, the reject tray 423, and the cash dispenser LED (light emitting diode) 44 (described later). They are exposed below and in front of the cash tray 70 and the coin insertion slot 421. The coin dispenser tray 422 is a tray that receives coins dispensed as change from the change dispenser machine for coins 42. The reject tray 423 is next to and at the right of the coin dispenser tray 422. The reject tray 423 is a tray that receives coins not to be stored in the change dispenser machine for coins 42 such as deformed coins, foreign coins, and counterfeit coins (reject coins). The positional relation between the coin insertion slot 421, the coin dispenser tray 422, and the reject tray 423 depends on the structure of the change dispenser machine for coins 42.

Further, the first housing 11 includes the bill acceptor slot 411 and the bill dispenser slot 412 of the change dispenser machine for bills 41. They are exposed below and in front of the coin dispenser tray 422 and the reject tray 423. The bill acceptor slot 411 is a slot that accepts bills inserted for payment by a customer into the change dispenser machine for bills 41. The bill dispenser slot 412 is a slot that dispenses bills as change from the change dispenser machine for bills 41.

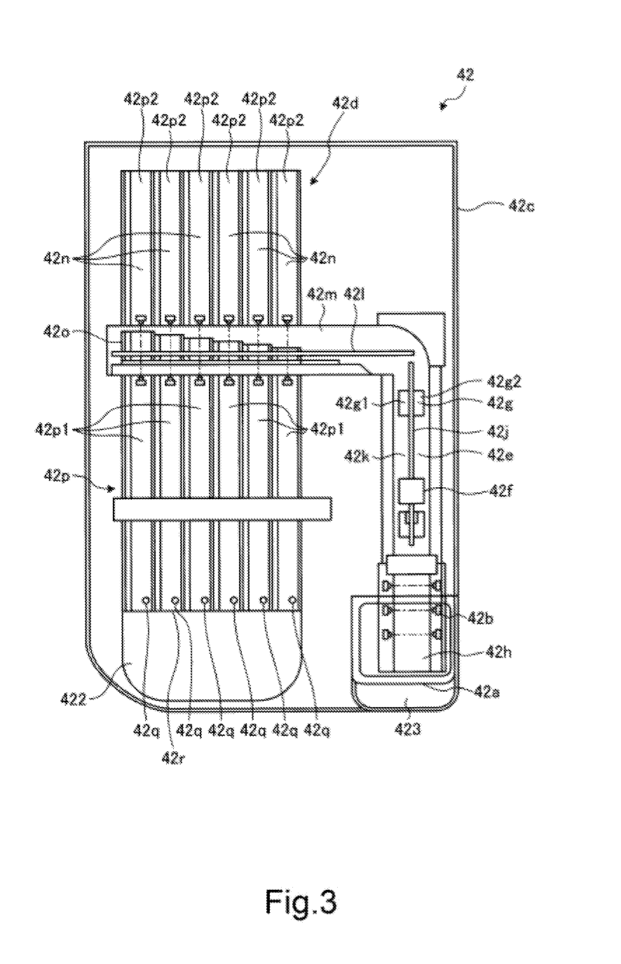

FIG. 3 is a plan view schematically showing an inner structure of the change dispenser machine for coins 42 housed in the first housing 11 of the payment apparatus 1. The change dispenser machine for coins 42 includes the coin acceptor unit 42a below the coin insertion slot 421 of the first housing 11. Further, the change dispenser machine for coins 42 includes the flat belt 42h and the coin detector 42b of the coin acceptor unit 42a. Further, the change dispenser machine for coins 42 includes, in the housing 42c, the storage device 42d, the accepted cash conveyer device 42e, the accepted cash discriminating device 42f, and the reject device 42g.

The coin detector 42b includes three pairs of through-beam photo sensors. The coin detector 42b detects coins inserted in the coin insertion slot 421 of the first housing 11 and accepted by the coin acceptor unit 42a. When the coin detector 42b detects coins, the change dispenser machine for coins 42 drives the flat belt 42h, conveys the coins in the housing 42c, and thereby accepts the coins. The accepted cash conveyer device 42e further conveys the accepted coins in the housing 42c.

The accepted cash conveyer device 42e conveys the accepted coins, which are conveyed by the flat belt 42h of the coin acceptor unit 42a, to the storage device 42d in order at predetermined spaces therebetween. The accepted cash conveyer device 42e includes the conveyer belt 42j and the conveyer path 42k. The conveyer belt 42j conveys coins along the conveyer path 42k. Further, the accepted cash conveyer device 42e includes the conveyer belt 421 and the conveyer path 42m. The conveyer belt 42j is approximately perpendicular to the conveyer belt 421. Further, the conveyer path 42k is approximately perpendicular to the conveyer path 42m.

The flat belt 42h conveys the coins accepted by the coin acceptor unit 42a inside the change dispenser machine for coins 42, and passes the coins to the conveyer belt 42j. Next, the conveyer motor 42e1 (described later) drives the conveyer belt 42j and the conveyer belt 421. When the conveyer belt 42j and the conveyer belt 421 are driven, the coins are conveyed to the top of the storage device 42d via the conveyer path 42k and the conveyer path 42m. The storage device 42d stores a predetermined number of coins of each kind. The storage device 42d includes the storages 42n, the number of the storages 42n being the same as the number of kinds of coins. In other words, the storage device 42d includes the storages 42n for different kinds of coins. The sort openings 42o are provided above the storages 42n of the storage device 42d, respectively. Each of the sort openings 42o drops off coins of the kind only corresponding to the coins stored in each of the storages 42n. The size of each of the sort openings 42o corresponds to the diameter of the coins to be dropped off. Coins are conveyed by the conveyer belt 421 along the conveyer path 42m, and drop off a storage 42n from a sort opening 42o, whose size corresponds to the diameter of the coins, when the coins pass through the sort openings 42o. The coins dropped off from the sort opening 42o are stored in the storage 42n of the corresponding kind. Therefore, the sort openings 42o sort the coins conveyed along the conveyer path 42m for the respective kinds, and the storages 42n store the coins of the respective kinds.

The accepted cash discriminating device 42f outputs voltages corresponding to the properties of coins passing through the detective range of the accepted cash discriminating device 42f. Specifically, the accepted cash discriminating device 42f includes an outer diameter sensor, a material sensor, and a thickness sensor in the conveyer path 42k. The outer diameter sensor detects outer diameters of coins passing through the detective range of the sensor. The material sensor detects materials of the coins passing through the detective range of the sensor. The thickness sensor detects thicknesses of the coins passing through the detective range of the sensor. Further, each sensor outputs voltages (detected results) corresponding to the detected results of the respective properties of the coins. Further, the controller 600 (described later) determines the kinds of coins on the basis of the output from the accepted cash discriminating device 42f, and, for example, counts the number of the coins of the respective kinds. Further, the controller 600 determines whether the coins are genuine or counterfeit on the basis of the output from the accepted cash discriminating device 42f. Note that the controller 600 determines, as counterfeit coins, not only counterfeit coins but also genuine coins, whose surfaces are worn at a predetermined level or more, and genuine coins, which are deformed at a predetermined level or more.

The reject device 42g is in a middle of the conveyer path 42k, and at a downstream of the accepted cash discriminating device 42f in the direction of conveying coins. The reject device 42g includes the reject opening 42g1, from which coins drop off, and the shutter 42g2 capable of opening and closing the reject opening 42g1. When the shutter 42g2 closes the reject opening 42g1 totally or partially, all the coins conveyed by the accepted cash conveyer device 42e are conveyed to the storage device 42d without dropping off from the reject opening 42g1. When the shutter 42g2 opens the reject opening 42g1, coins conveyed by the accepted cash conveyer device 42e drop off from the reject opening 42g1 and are removed from the conveyer path 42k. The removed coins are discharged to the reject tray 423.

Further, the change dispenser machine for coins 42 includes the cash-to-be-dispensed conveyer devices 42p and the cash-to-be-dispensed discriminating devices 42q for the storages 42n, respectively. Each of the cash-to-be-dispensed conveyer devices 42p includes, as a movement mechanism, the cash dispenser path 42p1 and the cash dispenser belt 42p2. When the cash dispenser motors 42p3 are driven in the positive direction, the cash dispenser belts 42p2 are driven to convey coins in the cash dispensing direction. The driven cash dispenser belts 42p2 convey coins stored in the storages 42n along the cash dispenser paths 42p1. The coins conveyed along the cash dispenser paths 42p1 are dispensed to the coin dispenser tray 422 as change. The cash-to-be-dispensed discriminating devices 42q are provided on the cash dispenser paths 42p1 of the respective storages 42n and immediately before the coin dispenser opening 42r. Similar to the accepted cash discriminating device 42f, each of the cash-to-be-dispensed discriminating devices 42q includes an outer diameter sensor, a material sensor, and a thickness sensor. The outer diameter sensor detects outer diameters of coins passing through the detective range of the sensor. The material sensor detects materials of the coins passing through the detective range of the sensor. The thickness sensor detects thicknesses of the coins passing through the detective range of the sensor. Further, each sensor outputs voltages (detected results) corresponding to the respective properties of the coins. Further, the controller 600 counts the number of the dispensed coins of the respective kinds on the basis of the output from the cash-to-be-dispensed discriminating devices 42q.

The cash dispenser LED 44 is on the front rim of the coin dispenser tray 422. The cash dispenser LED 44 is in parallel with the front rim of the coin dispenser tray 422 and has a long bar shape. The cash dispenser LED 44 is turned on when coins are dispensed. Further, the cash dispenser LED 44 blinks when the coins corresponding to the change amount are not dispensed after a predetermined time period passes.

Next, a hardware configuration of the change dispenser machine for coins 42 controlled by the controller 600 will be described. FIG. 4 is a block diagram showing a hardware configuration of the change dispenser machine for coins 42. As shown in FIG. 4, the change dispenser machine for coins 42 includes the controller 600 as a hardware configuration. The controller 600 includes the CPU (Central Processing Unit) 610, the ROM (Read Only Memory) 620, and the RAM (Random Access Memory) 630. The CPU 610 functions as a main controller. The ROM 620 stores various programs. Various data is loaded in the RAM 630. Further, the change dispenser machine for coins 42 includes the memory device 64 and other devices. The memory device 64 stores various program and data. The CPU 610, the ROM 620, the RAM 630, and the memory device 64 are connected to each other via the data bus 65. The CPU 610 loads a control program, which is stored in the ROM 620 or the memory device 64, in the RAM 630 and executes the control program, and thereby the controller 600 executes control processing (described later).

The RAM 630 includes the logical number area 632 and the number-of-dispensed-coins area 633. The logical number area 632 stores the kinds of coins to be dispensed as change and the numbers of the coins of the respective kinds, which are determined by the controller 600 on the basis of change information. The number-of-dispensed-coins area 633 stores the kinds of coins and the counted number of the coins of the respective kinds, which are determined by the controller 600 on the basis of output from the cash-to-be-dispensed discriminating devices 42q. In other words, the number-of-dispensed-coins area 633 stores the kinds and numbers of coins, which are actually dispensed to the coin dispenser tray 422 by the change dispenser machine for coins 42.

The memory device 64 includes a nonvolatile memory such as an HDD (Hard Disc Drive) and a flash memory, which stores information after power-off. The memory device 64 includes the control program area 641 that stores the control program. Further, the memory device 64 includes the genuine coin information area 642. The genuine coin information area 642 stores reference data. The controller 600 uses the reference data to determine whether accepted coins, i.e., coins passing through the detective range of the accepted cash discriminating device 42f, are genuine coins or not on the basis of output from the accepted cash discriminating device 42f. The controller 600 determines that accepted coins are genuine coins, where all the output from the accepted cash discriminating device 42f is within the range of the reference data stored in the genuine coin information area 642. Further, the memory device 64 includes the predetermined time period area 643. The predetermined time period area 643 stores a first predetermined time period, a second predetermined time period, and a third predetermined time period (described later). The first predetermined time period is a sufficient time period from the time at which change information is input to the time at which change is dispensed. The second predetermined time period is slightly longer than the first predetermined time period. The third predetermined time period is a time period sufficient to dispense coins in a retry operation (described later).

Further, the controller 600 is connected to the timer 67 via the data bus 65. The timer 67 counts elapsed time from predetermined timing.

Further, the controller 600 is connected to, via the data bus 65 and the input-and-output controller 66, the operation device 15, the display device 16, the accepted cash conveyer device 42e, the accepted cash discriminating device 42f, the reject device 42g, the cash-to-be-dispensed discriminating devices 42q, the cash-to-be-dispensed conveyer devices 42p, the cash dispenser LED 44, and the buzzer 45. The operation device 15 includes keys used to input various operations. The display device 16 displays various information. Controlled by the controller 600, the cash dispenser LED 44 is turned on, blinks, and is turned off. Controlled by the controller 600, the buzzer 45 outputs a sound to inform a customer that coins corresponding to a change amount are not dispensed.

The accepted cash conveyer device 42e includes the conveyer motor 42e1 and the like for driving the conveyer belt 42j and the conveyer belt 421. The reject device 42g includes a solenoid and the like for operating the shutter 42g2 in order to open and close the reject opening 42g1. The cash-to-be-dispensed conveyer devices 42p include the cash dispenser motors 42p3 and the like for driving the cash dispenser belts 42p2. Further, data corresponding to the detected results, which are output from the coin detector 42b, the accepted cash discriminating device 42f, and the cash-to-be-dispensed discriminating devices 42q, is input in the controller 600.

Further, the controller 600 is connected to the input device 27 via the data bus 65. The input device 27 includes, for example, a communication device (hereinafter, the input device 27 will be referred to as communication device). The communication device 27 inputs change information from the controller 500 of the payment apparatus 1 via the communication cable NT.

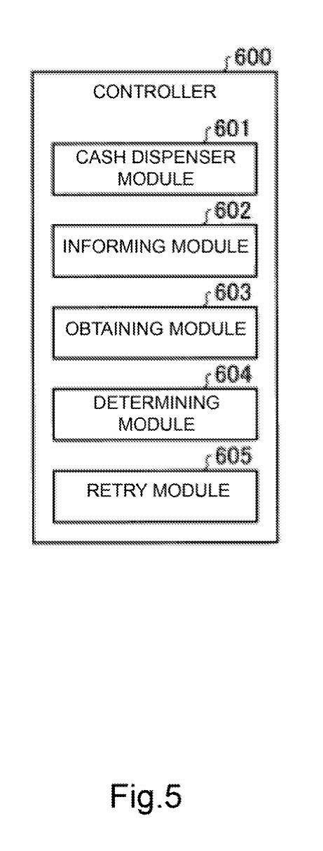

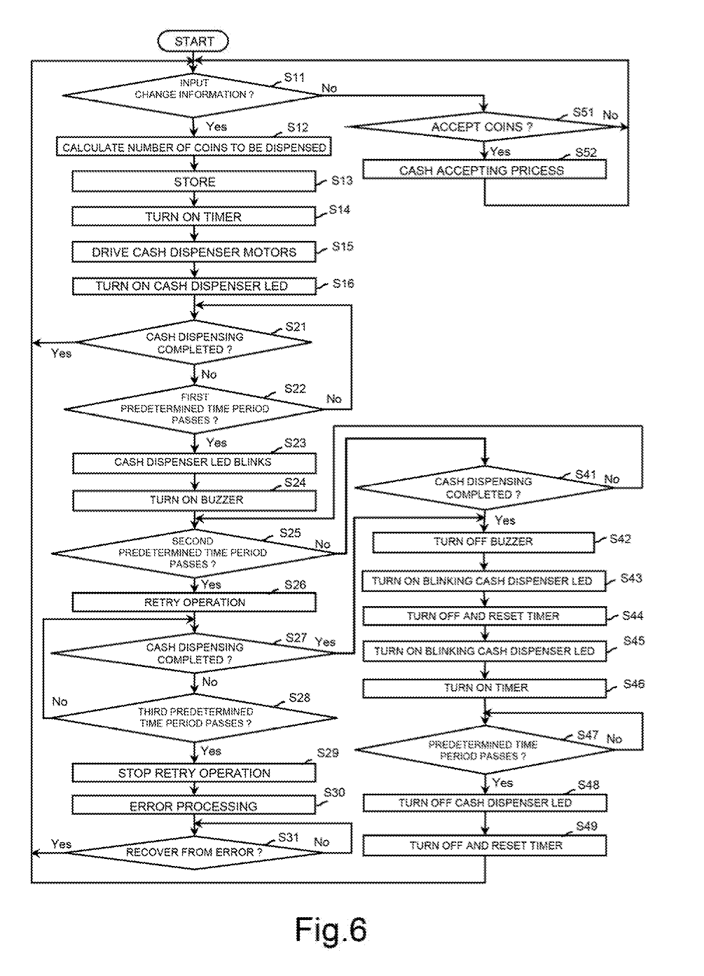

Next, with reference to FIG. 5 and FIG. 6, how to control the change dispenser machine for coins 42 will be described. FIG. 5 is a functional block diagram showing a functional configuration of the controller 600 of the change dispenser machine for coins 42. The controller 600 executes the control program, which is stored in the ROM 620 and/or the control program area 641 of the memory device 64, and thereby functions as the cash dispenser module 601, the informing module 602, the obtaining module 603, the determining module 604, and the retry module 605.

The cash dispenser module 601 causes the cash-to-be-dispensed conveyer devices 42p to start a cash-dispensing operation, the cash-dispensing operation including dispensing coins from the storage device 42d to the coin dispenser tray 422, an amount of the coins corresponding to a change amount based on change information input by using the communication device 27.

The informing module 602 determines whether coins corresponding to the change amount are dispensed or not. Where the informing module 602 determines that coins corresponding to the change amount are not dispensed, the informing module 602 informs that the cash-to-be-dispensed conveyer devices 42p are in the process of the cash-dispensing operation controlled by the cash dispenser module 601, i.e., the cash-dispensing operation is uncompleted. In other words, on condition that the coins corresponding to the change amount are not dispensed, the informing module 602 informs that the cash-to-be-dispensed conveyer devices 42p are in the process of the cash-dispensing operation controlled by the cash dispenser module 601 (the cash-dispensing operation is uncompleted).

The obtaining module 603 obtains information on coins dispensed by the cash dispenser module 601.

The determining module 604 determines whether the coins corresponding to the change amount are dispensed or not on the basis of the change information and the information on the dispensed coins.

The retry module 605 determines whether the coins corresponding to the change amount are dispensed or not after a predetermined time period passes from start of the cash-dispensing operation executed by the cash dispenser module 601. The retry module 605 executes a retry operation including moving the coins in the cash dispenser paths 42p1 in the cash dispensing direction and the direction opposite to the cash dispensing direction, where the coins corresponding to the change amount are not dispensed after the predetermined time period passes. In other words, on condition that the coins corresponding to the change amount are not dispensed after a predetermined time period passes from start of dispensing change by the cash dispenser module 601, the retry module 605 executes the retry operation including moving the coins in the cash dispenser paths 42p1 in the opposite direction and in the cash dispensing direction.

A customer inputs a sales register operation, and the reader device 5 of the payment apparatus 1 reads code symbols of products to be purchased. Then, the controller 500 of the payment apparatus 1 obtains product codes on the basis of the read code symbols, and executes sales register processing. Further, the controller 500 of the payment apparatus 1 executes payment processing for the products purchased by the customer on the basis of the sales register information. Then, when the controller 500 dispenses change to the customer, the controller 500 outputs change information on an amount of the change to be dispensed to the customer, to the change dispenser machine for coins 42 and the change dispenser machine for bills 41.

FIG. 6 is a flowchart showing a control processing of controlling the change dispenser machine for coins 42. As shown in FIG. 6, in Step S11, firstly, the controller 600 determines whether the payment apparatus 1 (the controller 500) inputs change information via the communication device 27 or not. Where the controller 600 determines that change information is not input (S11, No), the processing of the controller 600 proceeds to Step S51. In Step S51, the controller 600 determines whether the coin acceptor unit 42a accepts coins or not. Where the controller 600 determines that the coin acceptor unit 42a accepts coins (S51, Yes), the processing of the controller 600 proceeds to Step S52. In Step S52, the controller 600 executes cash accepting process for the coins. In other words, the controller 600 drives the flat belt 42h to accept the accepted coins. Further, the controller 600 drives the conveyer belt 42j and the conveyer belt 421 by using the conveyer motor 42e1, and thereby conveys the accepted coins. Further, the controller 600 determines the kinds of the accepted coins and whether the accepted coins are genuine or counterfeit on the basis of the output from the accepted cash discriminating device 42f. The sort openings 42o sort the genuine coins of the respective kinds, and the storages 42n of the storage device 42d store the coins. Meanwhile, reject coins including counterfeit coins, deformed coins, and worn coins are sorted into the reject device 42g, and discharged to the reject tray 423. When the cash accepting process of Step S52 is finished, the processing of the controller 600 returns to Step S11. Note that, in Step S51, where the controller 600 determines that coins are not accepted (S51, No), the processing of the controller 600 returns to Step S11.

Meanwhile, in Step S11, where the controller 600 determines that the payment apparatus 1 inputs change information (S11, Yes), the processing of the controller 600 proceeds to Step S12. In Step S12, firstly, the controller 600 calculates a change amount (change amount based on change information) of less than 1,000 yen, which is to be dispensed with coins, on the basis of the input change information. Further, the controller 600 determines the kinds and numbers of coins as change on the basis of the calculated change amount. In other words, the controller 600 determines the kinds of coins to be dispensed as change on the basis of change information, and calculates the number of each kind of the coins. Next, in Step S13, the controller 600 stores the calculated number of dispensed coins of each kind in the logical number area 632. Note that the change dispenser machine for bills 41 calculates a change amount (amount based on change information) of 1,000 yen or more every 1,000 yen, which is to be dispensed with bills, on the basis of the input change information.

Next, in Step S14, the controller 600 turns on (starts) the timer 67. Then, in Step S15, the controller 600 drives the cash dispenser motors 42p3 for driving the cash dispenser belts 42p2 corresponding to the kinds of coins to be dispensed as change. In this manner, the controller 600 (the cash dispenser module 601) starts to dispense coins as change, the change amount corresponding to the coins, to the coin dispenser tray 422. Then, in Step S16, the controller 600 turns on the cash dispenser LED 44 to thereby inform a customer that change is dispensed.

Next, in Step S21, the controller 600 (the determining module 604) determines whether coins corresponding to the change amount based on the change information are dispensed (cash dispensing is completed) or not. Specifically, the controller 600 (the obtaining module 603) obtains the number of coins of each kind (the number of dispensed coins of each kind) detected by each of the cash-to-be-dispensed discriminating devices 42q, and stores the number in the number-of-dispensed-coins area 633. The controller 600 compares the number of coins stored in the number-of-dispensed-coins area 633 with the number of coins stored in the logical number area 632 (see Step S13). As the result of the comparison, where the number of coins stored in the logical number area 632 is the same as the number of coins stored in the number-of-dispensed-coins area 633 for each of all the kinds of dispensed coins, the controller 600 determines that the coins corresponding to the change amount based on the change information are dispensed (cash dispensing is completed). Meanwhile, as the result of the comparison, where the number of coins stored in the number-of-dispensed-coins area 633 does not reach the number of coins stored in the logical number area 632, the controller 600 determines that the coins corresponding to the change amount based on the change information are not dispensed yet (cash dispensing is not completed). Note that the controller 600 may calculate the amount of the dispensed coins on the basis of the numbers of coins detected by the cash-to-be-dispensed discriminating devices 42q, compare the calculated amount with the change amount calculated on the basis of change information, and determine whether the coins are dispensed or not, the amount of the coins corresponding to the change amount.

In Step S21, where the controller 600 determines that cash dispensing is completed (Step S21, Yes), the processing of the controller 600 returns to Step S11. Further, where the controller 600 determines that cash dispensing is uncompleted (Step S21, No), the processing of the controller 600 proceeds to Step S22. In Step S22, the controller 600 turns on the timer 67 (see Step S14), and then determines whether the first predetermined time period passes or not. Whether the controller 600 determines that the first predetermined time period does not pass (Step S22, No), the processing of the controller 600 returns to Step S21. Where the controller 600 determines that the first predetermined time period passes (Step S22, Yes), the processing of the controller 600 proceeds to Step S23. In Step S23, the controller 600 causes the cash dispenser LED 44, which is turned on (see Step S16), to blink. Then, in Step S24, the controller 600 (the informing module 602) causes the buzzer 45 to output a sound to thereby inform a customer that the coins corresponding to the change amount are not dispensed yet, i.e., that it is in the process of the cash-dispensing operation.

Next, in Step S25, the controller 600 determines whether the second predetermined time period passes after the timer 67 is turned on (see Step S14) or not. Where the controller 600 determines that the second predetermined time period does not pass after the timer 67 is turned on (Step S25, No), the processing of the controller 600 proceeds to Step S41. In Step S41, the controller 600 determines whether the coins corresponding to the change amount based on the change information are dispensed (cash dispensing is completed) or not. Where the controller 600 determines that dispensing of the coins corresponding to the change amount is uncompleted (Step S41, No), the processing of the controller 600 returns to Step S25. Where the controller 600 determines that dispensing of the coins corresponding to the change amount is completed (Step S41, Yes), the processing of the controller 600 proceeds to Step S42. In Step S42, the controller 600 turns off the buzzer 45, which is turned on (see Step S24), to thereby stop informing the customer. Next, in Step S43, the controller 600 stops the cash dispenser motors 42p3 being driven (see Step S15). Then, in Step S44, the controller 600 turns off the timer 67, which is turned on (see Step S14), to thereby reset the timer 67.

Next, in Step S45, the controller 600 turns on the blinking cash dispenser LED 44 (see Step S23). In other words, the controller 600 changes the blinking status of the cash dispenser LED 44 to the lighting status to thereby inform the customer that dispensing of the coins corresponding to the change amount is completed. Next, in Step S46, the controller 600 turns on the timer 67. Next, in Step S47, the controller 600 turns on the timer 67 (see Step S46), and then determines whether a predetermined time period passes or not. This predetermined time period is a time period sufficient for a customer to take up change after the cash dispenser LED 44 is turned on (see Step S45). The controller 600 stands by until the predetermined time period passes (Step S47, No). Where the controller 600 determines that the predetermined time period passes (Step S47, Yes), the processing of the controller 600 proceeds to Step S48. In Step S48, the controller 600 turns off the cash dispenser LED 44. Then, in Step S49, the controller 600 turns off and resets the timer 67. In other words, all the processing of dispensing change of the controller 600 is finished. Then, the processing of the controller 600 returns to Step S11.

Meanwhile, in Step S25, where the controller 600 determines that the second predetermined time period passes after the timer 67 is turned on (S25, Yes), the processing of the controller 600 proceeds to Step S26. In Step S26, the controller 600 (the retry module 605) executes a retry operation for dispensing cash. If the coins corresponding to the change amount are not dispensed after the second predetermined time period passes, coins may jam in the cash dispenser paths 42p1. For example, the cash dispenser paths 42p1 may be clogged with coins. Therefore the controller 600 executes a retry operation, i.e., stops the cash dispenser motors 42p3 driving in the positive direction, and drives the cash dispenser motors 42p3 in the negative direction once. Then, after the driving in the negative direction, the controller 600 drives the cash dispenser motors 42p3 in the positive direction again. The controller 600 executes the retry operation once or repeats the retry operation a plurality of times. Then, the cash dispenser belts 42p2 travel in the direction opposite to the cash dispensing direction once, and then travel in the cash dispensing direction. Accordingly, also, coins on the cash dispenser belts 42p2 are moved in the direction opposite to the cash dispensing direction once, and then moved in the cash dispensing direction. As described above, the retry operation includes moving coins in the direction opposite to the cash dispensing direction, and then moving the coins in the cash dispensing direction. Alternatively, the retry operation includes moving coins in the direction opposite to the cash dispensing direction, then moving the coins in the cash dispensing direction, and repeating them a plurality of times. By executing the retry operation, jamming coins and/or coins clogging the paths may be removed.

Next, in Step S27, the controller 600 determines whether the coins corresponding to the change amount based on the change information are dispensed (cash dispensing is completed) or not. Where the controller 600 determines that cash dispensing is completed (S27, Yes), the controller 600 executes the above-mentioned processing of Step S42 and thereafter. Where the controller 600 determines that cash dispensing is uncompleted (S27, No), the processing of the controller 600 proceeds to Step S28. In Step S28, the controller 600 determines whether the third predetermined time period passes after the timer 67 is turned on (see Step S14) or not. Where the controller 600 determines that the third predetermined time period does not pass (Step S28, No), the processing of the controller 600 returns to Step S27. Where the controller 600 determines that the third predetermined time period passes (Step S28, Yes), the processing of the controller 600 proceeds to Step S29. In Step S29, the controller 600 stops the started retry operation (see Step S26). In other words, the controller 600 determines that jamming coins and/or coins clogging the paths are not removed after the predetermined time period passes, and stops the retry operation. Then, in Step S30, the controller 600 executes an error processing including displaying an error showing that coins are jamming or the paths are clogged with coins. An operator (for example, store worker) opens the inside of the change dispenser machine for coins 42, for example, and executes an error recovery operation. In Step S31, the controller 600 determines whether the change dispenser machine for coins 42 recovers from the error or not. The controller 600 stands by until the change dispenser machine for coins 42 recovers from the error (S31, No). Where the controller 600 determines that the change dispenser machine for coins 42 recovers from the error (Step S31, Yes), the processing of the controller 600 returns to Step S11.

The change dispenser machine for coins 42 housed in the first housing 11 of the payment apparatus 1 executes the control processing of FIG. 6 on the basis of the change information as the result of the payment processing executed by the payment apparatus 1.

As described above, according to this embodiment, on condition that coins corresponding to a change amount are not dispensed after a predetermined time period passes, the change dispenser machine for coins 42 causes the buzzer 45 to output a sound indicating that dispensing of change from the change dispenser machine for coins 42 is uncompleted (in the process of the cash-dispensing operation), and informs a customer that dispensing of change is uncompleted (see Step S24). Therefore, the change dispenser machine for coins 42 has a simple structure and is capable of preventing a customer from leaving change.

Further, according to this embodiment, the payment apparatus 1 houses the change dispenser machine for coins 42. So, on condition that coins corresponding to a change amount are not dispensed after a predetermined time period passes, the payment apparatus 1 causes the buzzer 45 to output a sound indicating that dispensing of change from the change dispenser machine for coins 42 is uncompleted (in the process of the cash-dispensing operation) to thereby inform a customer that dispensing of change is uncompleted. Therefore, the payment apparatus 1 has a simple structure and is capable of preventing a customer from leaving change.

Note that the method of informing a customer that coins corresponding to a change amount are being dispensed is not limited to the method of the above-mentioned embodiment. For example, in this embodiment, the change dispenser machine for coins 42 or the payment apparatus 1 causes the buzzer 45 to output a sound to thereby inform a customer that coins corresponding to a change amount are being dispensed. Alternatively, the operation device 15 (FIG. 4) of the change dispenser machine for coins 42 or the monitor 61 (FIG. 1) of the payment apparatus 1 may display that coins corresponding to a change amount are being dispensed to thereby inform that. Further, the blinking cash dispenser LED 44 may inform a customer that coins are being dispensed.

Further, according to this embodiment, in the change dispenser machine for coins 42 and the payment apparatus 1, where cash dispensing is uncompleted, the controller 600 turns on the timer 67 in Step S14, and then causes the buzzer to output a sound after the first predetermined time period passes. To the contrary, for example, the controller 600 may cause the buzzer 45 to output a sound at the timing of start of the retry operation in Step S26. Further, where the controller 600 executes the retry operation a plurality of times, the controller 600 may cause the buzzer 45 to output a sound at the timing of start of the second retry operation or thereafter. Further, immediately after turning on the timer 67 in Step S14, the controller 600 may cause the buzzer 45 to output a sound on condition that coins corresponding to a change amount are not dispensed.

Further, in the above-mentioned embodiment, the cash dispenser apparatus is the change dispenser machine for coins 42. Alternatively, the cash dispenser apparatus may be the change dispenser machine for bills 41. In this case, a bill is an example of cash.

Further, in this embodiment, the payment apparatus 1 informs a customer by using the buzzer 45 of the change dispenser machine for coins 42. To the contrary, a buzzer of the payment apparatus 1 may inform a customer.

Further, in this embodiment, the self checkout apparatus 100, which is operated by a customer for the sales register processing and payment processing, includes the payment apparatus 1. To the contrary, a semi-self type checkout apparatus, which is operated by a store worker for the sales register processing and operated by a customer for the payment processing, may include the payment apparatus 1.

Further, in this embodiment, the self checkout apparatus 100, which is operated by a customer for the sales register processing and payment processing, includes the change dispenser machine for coins 42. To the contrary, the change dispenser machine for coins 42 may be connected to a POS terminal operated by a store worker, and may be a change dispenser machine for coins operated by a store worker.

Note that the program executed by the change dispenser machine for coins 42 or the payment apparatus 1 of this embodiment is recorded in an installable format file or an executable format file in a computer readable recording medium such as a CD-ROM, a flexible disk (FD), a CD-R, and a DVD (Digital Versatile Disk) and provided.

Further, the program executed by the change dispenser machine for coins 42 or the payment apparatus 1 of this embodiment may be stored in a computer connected to a network such as the Internet, downloaded via the network, and provided. Further, the program executed by the change dispenser machine for coins 42 or the payment apparatus 1 of this embodiment may be provided or distributed via a network such as the Internet.

Further, the program executed by the change dispenser machine for coins 42 or the payment apparatus 1 of this embodiment may be preinstalled in the ROM or the like and provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A cash dispenser apparatus, comprising:
a storage device that stores cash;
an input device that inputs change information;
a cash-to-be-dispensed conveyer device that dispenses cash from the storage device;
an informing device that informs that cash is being dispensed; and
a controller that
causes the cash-to-be-dispensed conveyer device to start a cash-dispensing operation, the cash-dispensing operation including dispensing cash from the storage device, an amount of the cash corresponding to a change amount based on the change information input by using the input device, and
causes the informing device to execute the informing operation on condition that the cash-dispensing operation is uncompleted.

2. The cash dispenser apparatus according to claim 1, further comprising:
a sensor that detects cash dispensed by the cash-to-be-dispensed conveyer device, wherein
the controller
obtains information on the dispensed cash on a basis of a result detected by the sensor,
determines whether the cash-dispensing operation executed by the cash-to-be-dispensed conveyer device is completed or not on a basis of the change amount based on the change information and on a basis of the obtained information on the cash, and
causes the informing device to execute the informing operation, where the controller determines that the cash-dispensing operation executed by the cash-to-be-dispensed conveyer device is uncompleted.

3. The cash dispenser apparatus according to claim 2, wherein
the controller causes the informing device to execute the informing operation, where the controller determines that the cash-dispensing operation is uncompleted after a predetermined time period passes from start of the cash-dispensing operation executed by the cash-to-be-dispensed conveyer device.

4. The cash dispenser apparatus according to claim 1, wherein
the cash-to-be-dispensed conveyer device includes a movement mechanism that moves cash in a cash dispensing direction and in an opposite direction, the cash dispensing direction being a direction of dispensing cash from the storage device, the opposite direction being a direction opposite to the cash dispensing direction, and
the controller executes a retry operation on condition that the cash-dispensing operation is uncompleted, the retry operation including driving the movement mechanism and moving cash in the opposite direction and in the cash dispensing direction.

5. The cash dispenser apparatus according to claim 4, wherein
the controller causes the informing device to execute the informing operation on condition that the cash-dispensing operation is uncompleted and execution of the retry operation is started.

6. A checkout system, comprising:
a payment apparatus that
executes sales register processing for a product,
executes payment processing for the product, the sales register processing for the product being completed, and
outputs change information on a basis of a result of the payment processing; and
a cash dispenser apparatus that dispenses cash on a basis of the change information output from the payment apparatus, an amount of the cash corresponding to a change amount,
the cash dispenser apparatus including
a storage device that stores cash,
an input device that inputs the change information from the payment apparatus,
a cash-to-be-dispensed conveyer device that dispenses cash from the storage device to an outside of the cash dispenser apparatus,
an informing device that informs that cash is being dispensed, and
a controller that
causes the cash-to-be-dispensed conveyer device to start a cash-dispensing operation, the cash-dispensing operation including dispensing cash from the storage device, an amount of the cash corresponding to a change amount based on the change information input by using the input device, and
causes the informing device to execute the informing operation on condition that the cash-dispensing operation is uncompleted.

7. The checkout system according to claim 6, wherein
the cash dispenser apparatus further includes a sensor that detects cash dispensed by the cash-to-be-dispensed conveyer device, and
the controller
obtains information on the dispensed cash on a basis of a result detected by the sensor,
determines whether the cash-dispensing operation executed by the cash-to-be-dispensed conveyer device is completed or not on a basis of the change amount based on the change information and on a basis of the obtained information on the cash, and
causes the informing device to execute the informing operation, where the controller determines that the cash-dispensing operation executed by the cash-to-be-dispensed conveyer device is uncompleted.

8. The checkout system according to claim 7, wherein
the controller causes the informing device to execute the informing operation, where the controller determines that the cash-dispensing operation is uncompleted after a predetermined time period passes from start of the cash-dispensing operation executed by the cash-to-be-dispensed conveyer device.

9. The checkout system according to claim 6, wherein
the cash-to-be-dispensed conveyer device includes a movement mechanism that moves cash in a cash dispensing direction and in an opposite direction, the cash dispensing direction being a direction of dispensing cash from the storage device, the opposite direction being a direction opposite to the cash dispensing direction, and
the controller executes a retry operation on condition that the cash-dispensing operation is uncompleted, the retry operation including driving the movement mechanism and moving cash in the opposite direction and in the cash dispensing direction.

10. The checkout system according to claim 9, wherein
the controller causes the informing device to execute the informing operation on condition that the cash-dispensing operation is uncompleted and execution of the retry operation is started.

11. A cash dispensing method, executed by a cash dispenser apparatus including a storage device that stores cash, an input device that inputs change information, a cash-to-be-dispensed conveyer device that dispenses cash from the storage device to an outside of the cash dispenser apparatus, and an informing device that informs that cash is being dispensed, the cash dispensing method comprising:
causing the cash-to-be-dispensed conveyer device to start a cash-dispensing operation, the cash-dispensing operation including dispensing cash from the storage device, an amount of the cash corresponding to a change amount based on the change information input by using the input device;
determining whether the cash-dispensing operation is completed or not; and
causing the informing device to execute the informing operation, where the controller determines that the cash-dispensing operation is uncompleted.
